(19) United States
(12) Patent Application Publication
(10) Pub. No.: US 2015/0121675 A1
(43) Pub. Date: May 7, 2015

(54) AXLE HUB PULLER

(71) Applicant: Joseph Richard Campoli, Mishawaka, IN (US)

(72) Inventor: Joseph Richard Campoli, Mishawaka, IN (US)

(21) Appl. No.: 14/071,527

(22) Filed: Nov. 4, 2013

(51) Int. Cl. B25B 27/00; B25B 27/02

(52) U.S. Cl. CPC B25B 27/0035; B25B 27/023
USPC 29/426.5; 29/266

(57) ABSTRACT

An axle hub puller may include a puller body. The puller body may include a plurality of counter sink holes and a threaded puller screw hole. The puller body may be operable to removably attach to hub with a plurality of wheel lugs by having the plurality of wheel lugs pass through the plurality of counter sink holes. A puller screw may be inserted into the threaded puller screw hole. The puller screw may be turned against a hub axle center allowing for the removal of the hub and a brake rotor.

### BACKGROUND OF THE INVENTION

The present invention relates to the removal of hubs and, more particularly, to an axle hub puller.

Currently, devices used to pull a front axle hub off are weak and hard to use. These devices are of poor quality and design. Situations occur where the puller may bind on the axle shaft.

As can be seen, there is a need for an axle hub puller that provides a smooth and equal pulling force on the hub that may keep it from binding on the axle shaft during the removal of the hub.

### SUMMARY OF THE INVENTION

In one aspect of the present invention, an axle hub puller comprises: a puller body comprising a plurality of counter sink holes and a threaded puller screw hole, wherein the puller body is operable to removably attach to a plurality of wheel lugs through the plurality of counter sink holes; and a puller screw turned in against a hub axle center through the puller screw hole.

In another aspect of the present invention, a method of removing a hub and brake rotor off of an axle comprises: removing a tire and brake caliper from the axle; removing a center axle nut; attaching puller body onto a plurality of wheel lugs of the axle, wherein the puller body comprises a plurality of counter sink holes and a threaded puller screw hole, wherein the plurality of wheel lugs of the axle enter through the plurality of counter sink holes of the puller body; tightening a plurality of lug nuts over the plurality of wheel lugs; engaging a puller screw into the puller screw hole of the puller body; turning the puller screw in against an axle center; and removing the hub and brake rotor off of the axle.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a side view of an exemplary embodiment of the present invention;

FIG. 3 is a bottom view of an exemplary embodiment of the present invention;

FIG. 4 is a top view of an exemplary embodiment of the present invention;

FIG. 5 is an exploded view of an exemplary embodiment of the present invention in use;

FIG. 6 is an exploded view of an exemplary embodiment of the present invention in use;

FIG. 7 is an exploded view of an exemplary embodiment of the present invention in use;

FIG. 8 is a perspective view of an exemplary embodiment of the present invention demonstrating the interface between an exemplary drill and a puller screw;

FIG. 9 is an exploded view of an exemplary embodiment of the present invention demonstrating the removal of an exemplary hub;

FIG. 10 is a section detail view of an exemplary embodiment of the present invention along line 10-10 in FIG. 8; and

FIG. 11 is a section detail view of an exemplary embodiment of the present invention demonstrating the removal of an exemplary hub.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an axle hub puller that may include a puller body. The puller body may include a plurality of counter sink holes and a threaded puller screw hole. The puller body may be operable to removably attach to a hub with a plurality of wheel lugs by having the plurality of wheel lugs pass through the plurality of counter sink holes. A puller screw may be inserted into the threaded puller screw hole. The puller screw may be turned against a hub axle center allowing for the removal of the hub and a brake rotor.

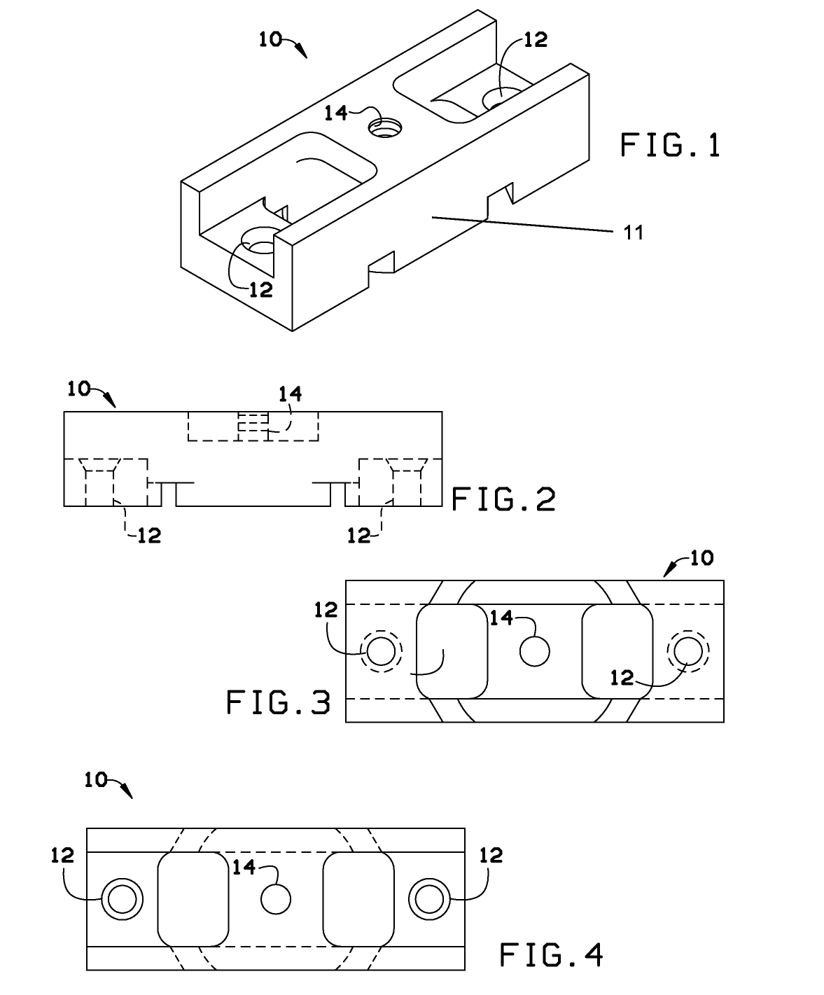

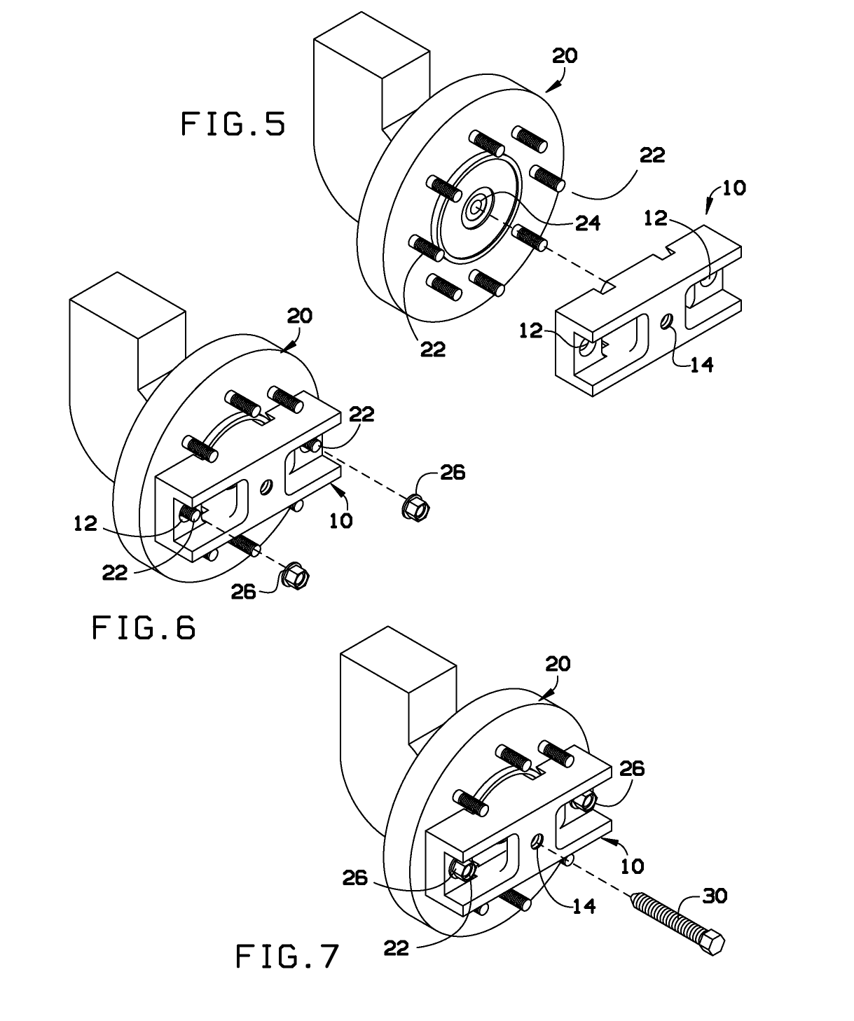

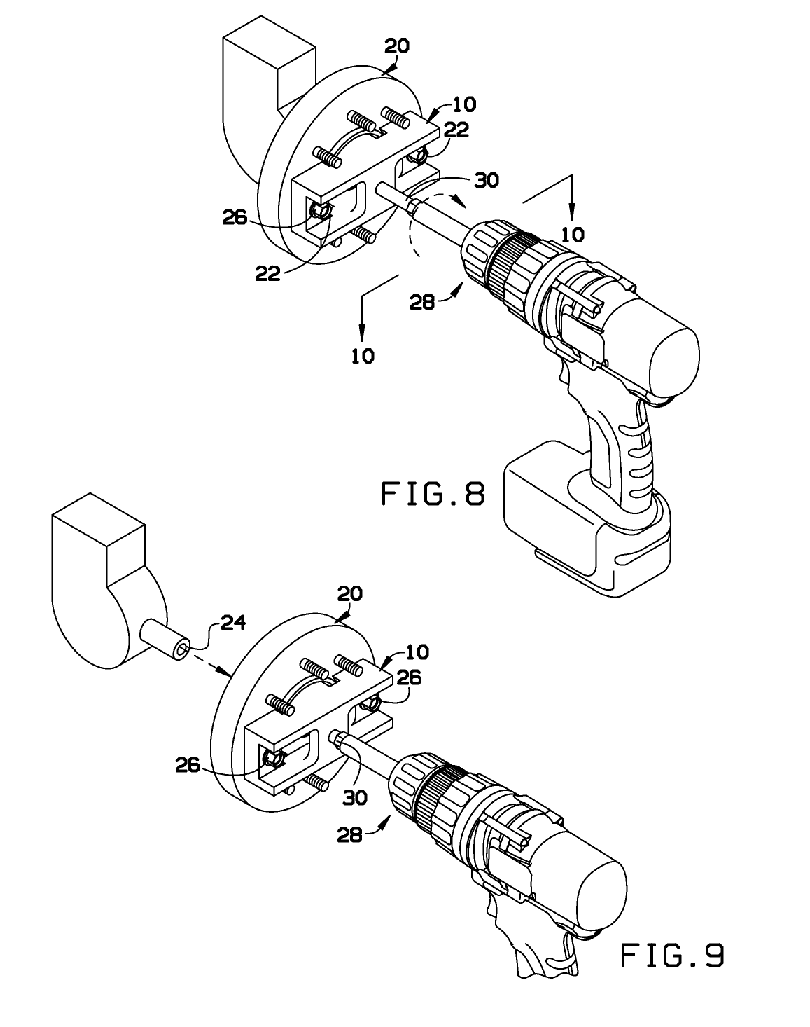

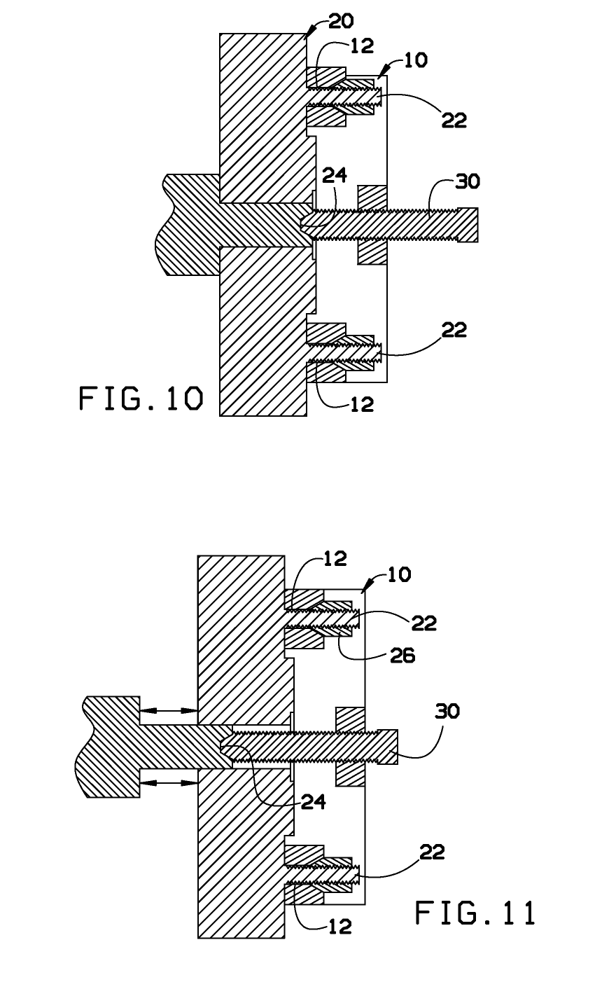

As is illustrated in FIGS. 1 through 11, the axle hub puller 10 may include a puller body 11. The puller body 11 may include a plurality of counter sink holes 12 along with a threaded puller screw hole 14. An axle of a car, such as a front axle, may be exposed by removing a tire and a brake caliper from the axle. An individual may remove a center axle nut. The hub 20 of the axle having a plurality of wheel axle lugs 22 attached, may then be accessed. The puller body 11 may be attached to the wheel lugs 22 by placing the counter sink holes 12 over the wheel lugs 22 on the hub 20. A plurality of lug nuts 26 may be placed over the plurality of wheel lugs 22 and the plurality of counter sink holes 12 of the puller body 11. An individual may then tighten the lug nuts 26 securing the puller body 11 to the hub 20. The threaded puller screw hole 14 may be positioned over an axle center 24. A puller screw 30 may be placed in the threaded puller screw hole 14 and turned. As the puller screw 30 may be turned against the axle center 24, the hub 20 and a brake rotor may be removed off of the axle together. Turning the puller screw 30 against the axle center 24 creates separation between the hub 20 and the brake rotor from the axle. The puller screw 30 may be turned by a drill 28 or other similar device.

The puller body may fit across the hub in a way that allows the puller body to be approximately symmetrical across the axle center. In certain embodiments, the plurality of counter sink holes may include two counter sink holes. In certain embodiments, the axle hub puller may be made from, but not limited to, steel or the like. The axle hub puller may be made from multiple pieces of flat stock steel and a fully threaded screw. In certain embodiments, five pieces of flat stock steel may be used and welded together. Holes may be drilled and the center hole may be threaded for the puller screw to work within the threaded puller screw hole.

In certain embodiments, the axle hub puller may be used for front axle hubs, rear axle hubs and the like. In certain embodiments, a hydraulic center push rod may be included to provide additional force. In certain embodiments, the axle hub puller may be used for pulling off gears, bearings, and the like.

It should be understood, of course, that the foregoing relates to exemplary embodiments of the invention and that modifications may be made without departing from the spirit and scope of the invention as set forth in the following claims.

What is claimed is:

1. An axle hub puller comprising:
a puller body comprising a plurality of counter sink holes and a threaded puller screw hole, wherein the puller body is operable to removably attach to a plurality of wheel lugs through the plurality of counter sink holes; and
a puller screw turned in against a hub axle center through the puller screw hole.

2. The axle hub puller of claim 1, wherein the axle hub comprises the front axle hub.

3. The axle hub puller of claim 1, wherein the axle hub comprises the rear axle hub.

4. The axle hub puller of claim 1, wherein the plurality of counter sink holes comprises two counter sink holes.

5. A method of removing a hub and a brake rotor off of an axle comprising:
removing a tire and brake caliper from the axle;
removing a center axle nut;
attaching a puller body onto a plurality of wheel lugs of the axle, wherein the puller body comprises a plurality of counter sink holes and a threaded puller screw hole, wherein the plurality of wheel lugs of the axle enter through the plurality of counter sink holes of the puller body;
tightening a plurality of lug nuts over the plurality of wheel lugs;
engaging a puller screw into the puller screw hole of the puller body;
turning the puller screw in against an axle center; and
removing the hub and the brake rotor off of the axle.
